(19) United States
(12) Patent Application Publication
(10) Pub. No.: US 2011/0128006 A1
(43) Pub. Date: Jun. 2, 2011

(54) Method and apparatus for detecting battery life

(75) Inventors: Li Ren, Xiaoshan (CN); Peter Shih Hsin Ying, Plano, TX (US); Chengjie Ge, Hangzhou (CN); Xi Danji, Xiaoshan (CN)

(73) Assignee: Helix Micro, Milpitas, CA (US)

(21) Appl. No.: 12/628,881

(22) Filed: Dec. 1, 2009

(51) Int. Cl. G01N 27/27

(52) U.S. Cl. 324/426

(57) ABSTRACT

A system and method for determining life of a rechargeable battery. Data representing relationship between lasting time of the battery and equivalent number of life cycles of the battery is provided; lasting time of the battery in charging is obtained; and the life of the battery is determined utilizing the obtained lasting time and the data provided.

### TECHNICAL FIELD OF THE INVENTION

The present invention relates to battery power management, and more particularly to a method and apparatus for detecting life of a rechargeable battery.

### BACKGROUND OF THE INVENTION

One way to measure life cycle of a rechargeable battery is to measure the number of complete charge-discharge cycles a battery can perform before its nominal capacity falls below 75% of its initial rated capacity. The complete charge-discharge cycles assume that the battery is fully charged and discharged in each cycle. However, the actual usable capacity of a battery varies with a number of factors in practical use, such as operating temperature, self discharge rate, battery aging, depth of discharge, et al. If the battery is only partially discharged each cycle, then life of the battery will be much greater. Once in use, the performance of a battery is determined by the actual usage with partial charge or discharge. Thus the effective life consumed or remained of the battery is hard to detect.

There are methods available to determine remaining battery life based on internal resistance of a battery, for example, the method in U.S. Pat. No. 6,842,708. However, these methods require a complicated system to collect stable data of current and voltage, and to calculate the internal resistance for the purpose of monitoring battery life. In addition, these methods may be used to monitor the life of a battery, but insufficient to be used to predict the life of the battery, which may be used to provide reliable warning to the users.

Therefore, there is a need for a method to determine life of a battery in a simple and reliable manner.

### BRIEF SUMMARY OF THE INVENTION

A system and method for determining life of a rechargeable battery are provided. The system is adapted to provide data representing relationship between lasting time of the battery and equivalent number of life cycles of the battery; to obtain lasting time of the battery in charging; and to determine the life of the battery utilizing the obtained lasting time and the data provided.

### BRIEF DESCRIPTION OF THE SEVERAL VIEWS OF THE DRAWING

For a more complete understanding of the present invention, and for further advantages thereof, reference is now made to the following description taken in conjunction with the accompanying drawings in which:

FIG. 1 is a diagram illustrating relationship between the lasting time of a Lithium Ion battery and the equivalent life cycles the battery has performed according to one embodiment of the present invention;

FIG. 2 is a diagram illustrating curves of current and voltage of a Lithium Ion battery being charged using a constant current and constant voltage charging method;

FIG. 3 is a diagram illustrating curves of current and voltage of a Lithium Ion battery in constant current and constant voltage charging and in fast charging according to one embodiment of the present invention;

FIG. 4 is a diagram illustrating a curve of battery voltage of a Lithium Ion battery varying with charging time according to one embodiment of the present invention; and

FIG. 5 is a diagram illustrating a system for determining battery life consumed and/or remained according to one embodiment of the present invention.

### DETAILED DESCRIPTION OF THE INVENTION

The following discussion is presented to enable a person skilled in the art to make and use the invention. Various modifications will be readily apparent to those skilled in the art, and the general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

The actual usable capacity of a battery, and therefore the battery life, varies with a number of factors in practical use, such as operating temperature, self discharge rate, battery aging, depth of discharge, et al. For example, a battery ages as it is in active use. This causes the usable capacity of the battery to decrease, and therefore the battery needs to be charged more frequently. In another example, a battery may have self discharge even it is not in use. The self discharge may require the battery to be charged more often too. Deep discharge may also unbalance the characteristics of chemical-electrical relationship of a battery and reduce the battery life. The various factors that may affect the actual usable capacity of a battery may be described as wear-out factors of the battery. The term “wear-out” here is used only for description convenience, and should not be construed as limitation to the present invention.

Therefore, even if a new battery is specified with a value indicating it's maximum possible life, e.g., 1000 complete charge-discharge cycles, once the battery is in use, it is hard for the user or the system using the battery to determine how much battery life has been consumed or how much is remained quantitatively, due to the wear-out factors described above.

The embodiments of the present invention provide a method and system that are capable of determining consumed and/or remaining battery life by using equivalent number of complete charge-discharge cycles as an indicator of battery life. The complete charge-discharge cycles refer to cycles in each of which a battery is fully charged and discharged under an ideal condition, and will be referred to as “life cycles” of a battery in the following description. The consumed life refers to the equivalent life cycles a battery has performed. The embodiments will be able to provide quantitative battery life consumed or remained of a battery, which may be further used to provide safety indication or alarm for the battery.

In one embodiment of the present invention, the consumed battery life of a battery may be detected by monitoring charging time of the battery when the battery is in charging. A starting time is recorded when the battery begins to be charged, and an ending time is recorded when the charging stops. The charging time is measured as the time difference between the charging starting time and the charging ending time.

The charging time for a battery that has been fully discharged starting when the battery begins charging until the battery charging voltage reaches a threshold voltage is referred to as “lasting time”. The lasting time may be used to determine life of the battery, such as the number of life cycles the battery has performed, or the remaining life cycles the battery has. The threshold voltage is a voltage value of a battery under an optimal charging condition. For example, a threshold voltage for a Lithium Ion battery may be 4.2 V. The threshold voltage may vary for different types of batteries, and may be predetermined or pre-estimated for a certain type of battery by different methods or algorithms.

In practical use, wear-out factors may affect the usage of the battery. The actual number of charge-discharge cycles is far insufficient to indicate the actual battery life consumed. The lasting time, i.e., the time for the voltage of a rechargeable battery in charging to reach a threshold value, or the threshold voltage, is a dynamics parameter which is related to the battery aging process or wear-out status. The parameter varies with wear-out factors, such as battery connection and operating conditions, working environment, internal and ambient temperature, residual capacities, cell chemistry, cell size, discharge rate, form factor, or the number of the charge-discharge cycles a battery has been through. The lasting time reflects the actual performance of a battery under various wear-out situations, and may be used as an indicator of the health of the battery. Correlating the lasting time with the Equivalent Life Cycles (ELC) which are the ideal or rated life cycles of a battery under a full charge-discharge condition, users may have a clear understanding of how many life cycles the battery has been through or has performed, and how many life cycles are left or remained to go.

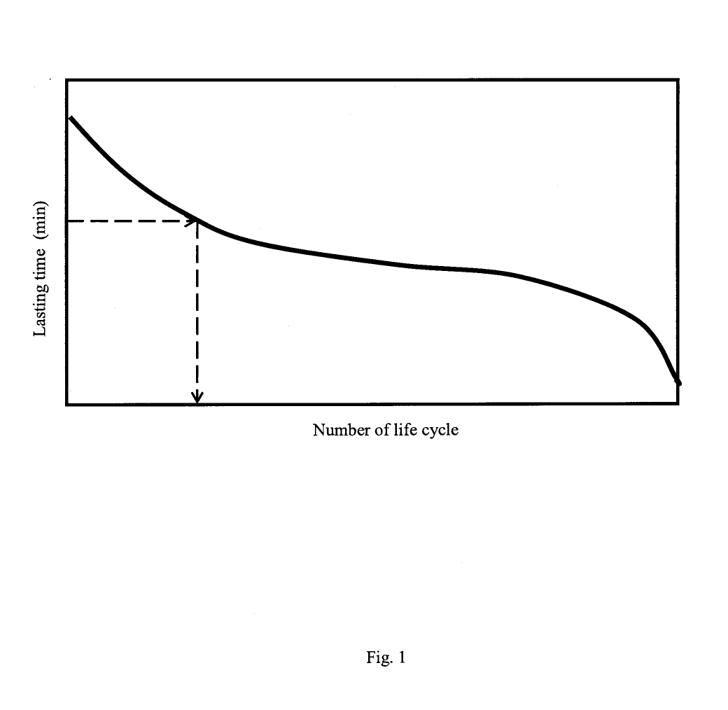

The relationship between the lasting time of a battery and the equivalent number of life cycles the battery has performed may be represented by a curve, referred to as an ideal “wear-out” curve. Referring to FIG. 1, a wear-out curve of a Lithium Ion battery is illustrated. The Lithium Ion battery is charged using a constant current and constant voltage charging method.

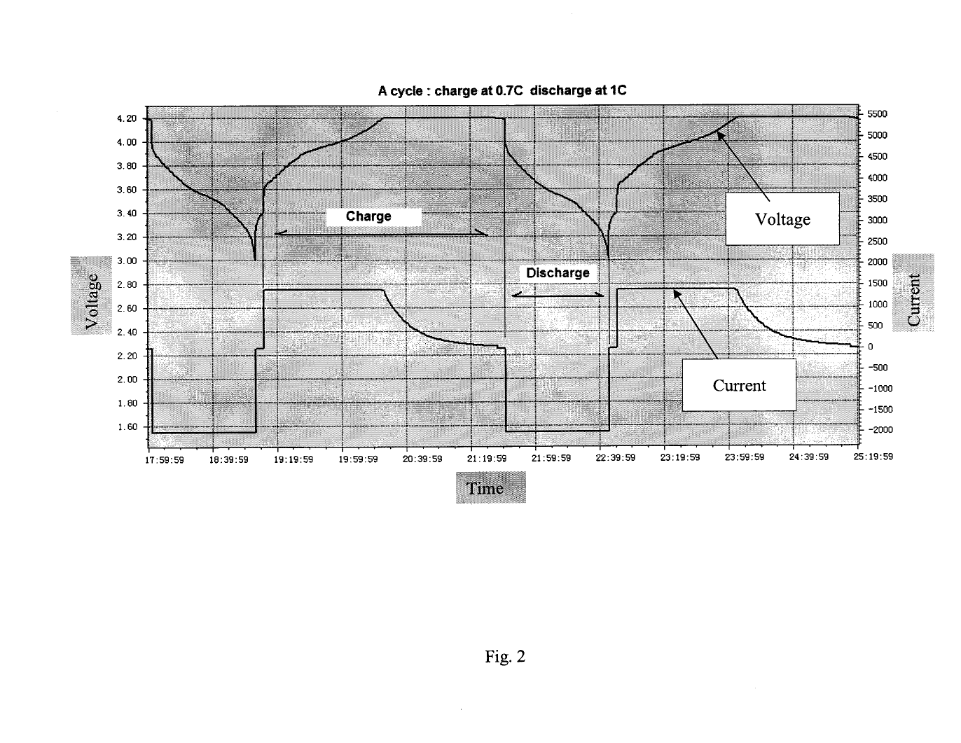

FIG. 2 illustrates curves of current and voltage of a Lithium Ion battery charged using the constant current and constant voltage charging method. The battery discharges at 1 C rate, and charging begins when the battery capacity is at 0.7 C rate. The battery is first charged at constant current. The battery voltage rises as charging progresses to a peak, which is the threshold voltage, 4.2V in this embodiment, then the battery is charged at this voltage constantly until the battery is fully charged.

Referring back to FIG. 1, as the number of life cycles the battery has performed increases, the lasting time decreases. Batteries may be categorized according to types, manufacturing, or other categorizing factors, and the wear-out curve in FIG. 1 may be different for different categories of batteries, e.g., different for the same type of batteries from different manufactures or in different manufacturing batches, or different in other applicable situations. But wear-out curves for batteries of the same category remain relatively stable. Therefore, the wear-out curve for each category of batteries may be obtained and stored beforehand for determining the actual life of a battery of the same category in use. By measuring the lasting time of a battery in a certain category and using the wear-out curve for the battery of the same category, the consumed and/or remaining life of the battery may be determined simply from the wear-out curve.

In one embodiment to determine life a battery in practical use has performed, one may first get the wear-out data for batteries of the same category ready, and determine the threshold voltage. When the battery has been fully discharged and charging begins, charging time and charging voltage of the battery are measured repeatedly at certain frequencies. For each measurement, the battery charging voltage may be compared with the threshold voltage. If the battery charging voltage has reached the threshold voltage, the charging time measured at the same time is taken as the lasting time for the battery in this cycle of charging. Using the measured lasting time and the predetermined wear-out data, one may easily find the corresponding equivalent number of life cycles the battery currently has performed.

The battery may be charged using various applicable charging methods. For example, the battery may be charged using the constant current and constant voltage charging method, variable current and/or variable voltage charging methods, or fasting charging methods. The threshold voltage may vary according to the charging methods actually used.

If the battery is being charged using the constant current and constant voltage charging method, instead of determining whether the charging voltage of the battery has reached the threshold voltage, one may detect whether the constant current charging has ended. The charging time used for constant current charging can be taken as the lasting time for the battery, i.e., the charging time measured at the end of the constant current charging is the lasting time. In this case, one may measure the battery current or battery voltage to determine whether the constant current charging ends. If battery current is measured to check whether the constant current charging ends, there is no need to provide beforehand the threshold voltage.

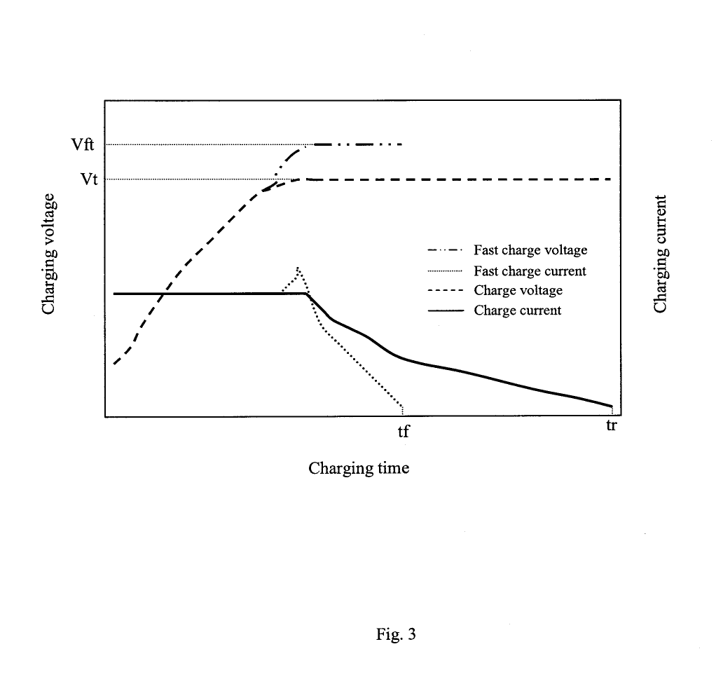

FIG. 3 illustrates curves of voltage and current of a Lithium Ion battery when the battery is charged using the constant current and constant voltage charging method and a fast charging method, respectively. As described above, for the constant current and constant voltage charging, the battery is first charged at a constant current, and the battery voltage increases when the charging proceeds. When the battery voltage reaches a threshold Vt, the battery is charged at constant voltage until the battery is fully charged at time tr. During the constant voltage charging, the battery current decreases as the charging proceeds.

If a higher current is applied at the end of the constant current charging, and then the battery is charged at a constant voltage, the time for the battery to be fully charged will be greatly reduced. This is known as fasting charging. As illustrated in FIG. 3, the battery may be fully charged at time tf. The current applied to the battery at the end the constant current charging may be 2 C or up to 10 C. In this case, the battery voltage at the end of the constant current charging may be higher than that in non-fasting charging. If a battery is charged using a fast charging method, a fast charging threshold voltage may be provided in the embodiments of the present invention to determine the life of the battery. The embodiments of the present invention may be applied to various fast charging methods that are applicable.

In practical uses, a battery may not always be fully discharged before its next charging begins. For example, a laptop user may begin to charge the laptop rechargeable battery when the battery bar shows that half or ⅓ capacity of the rechargeable battery is left. In this case, one may not be able to obtain the lasting time directly from measuring the charging time of the battery to determine the equivalent life cycles the battery has performed.

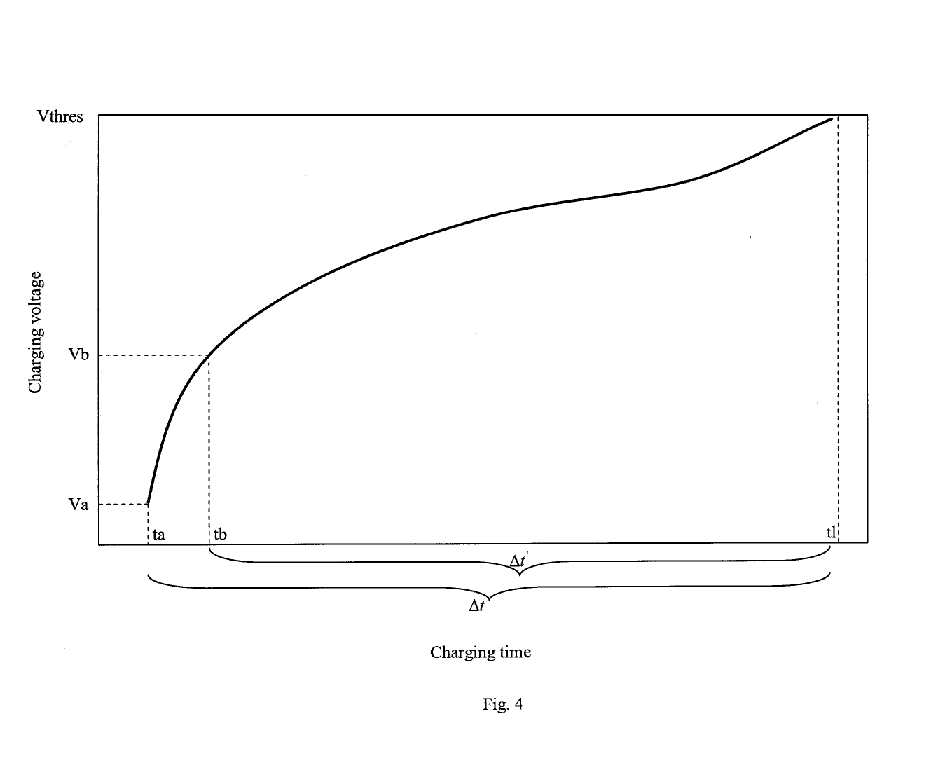

FIG. 4 illustrates a curve of charging voltage of a Lithium Ion battery varying with the charging time. The charging voltage of a battery increases as the battery is being charged until it reaches a threshold voltage Vthres. When a battery has been fully discharged and begins to be charged, the charging starting time is recorded as ta, and the battery voltage is Va. As the charging proceeds, the battery voltage is increasing. When the battery voltage reaches the threshold voltage Vthres, charging is stopped, and the charging ending time is recorded as tl. The charging time Δt=(tl−ta) is the lasting time of the battery. The lasting time will decrease because of various aging or wear-out factors after a battery is out of factory and no matter whether it is in active use or not. However, the battery voltage Va, which is the voltage of the battery after the battery is fully discharged and begins charging, remains the same.

If the battery begins the charging when it is not fully discharged, which is not unusual in practical use, the battery voltage when charging begins will be higher than Va. For example, the battery voltage is Vb in this case, and the charging starting time is recorded as ta′. The charging is stopped when the battery voltage reaches the threshold voltage Vthres, and the charging ending time is recorded as tl′. The charging time for the battery now is Δt′=(tl′−ta′). But the charging time is not the lasting time of the battery. In this case, the real lasting time Δt for the battery can not be measured directly.

To represent both the Δt and the Δt′ in FIG. 3, one may take tb as shown in FIG. 3 as an equivalent charging starting time of ta′, and take tl as the equivalent charging ending time of tl′, where (tl−tb)=Δt′, and tb corresponds to a battery voltage of Vb according to the voltage curve.

To use the predetermined wear-out curve to determine the life of the battery, we need to get the real lasting time Δt. Referring to FIG. 3, if charging begins for the battery when it is not in full discharge, the charging time Δt′ and the battery voltage Vb can be measured, the charging starting time tb and charging ending time tl can be recorded. The threshold voltage Vthres and the battery voltage when the battery is fully discharged Va are known parameters. What is needed to know is ta, and then Δt can be calculated as (tl−ta).

If the curve in FIG. 3 is represented as V(t), we have:

$$\begin{matrix}\frac{Δ {t}^{. ′}}{Δ {t}^{.}} = \frac{{\int }_{tb}^{tl} V ( t ) d t}{{\int }_{ta}^{tl} V ( t ) d t} & ( 1 ) \\ Δ t = Δ {t}^{′} * \frac{{\int }_{tb}^{tl} V ( t ) d t}{{\int }_{ta}^{tl} V ( t ) d t} & ( 2 )\end{matrix}$$

Therefore,

Where Δt′=(tl−tb).

To detect life of a battery in case one does not know whether the battery has been fully discharged or not, equation (2) can be used to calculate the lasting time of the battery from the charging time measured for the battery. The battery voltage-charging time function V(t) represents relationship between battery voltage and charging time of a battery in charging, and can be predetermined for each category of batteries beforehand from complete charge and discharge cycles of the batteries.

In one embodiment, one may first obtain the wear-out data for batteries of a certain category and the corresponding battery voltage-charging time function V(t), and provide a threshold voltage for charging. When a battery of the same category begins charging, the charging starting time, and the charging ending time when the battery voltage reaches the threshold voltage are recorded. Then equation (2) is used to calculate the lasting time of the battery. Using the lasting time and the wear-out data, an equivalent number of life cycles the battery has performed can be determined.

By obtaining the lasting time of a battery, an equivalent number of life cycles that have been performed by the battery and the remaining life of the battery may be easily and quickly determined using the predetermined wear-out curve. For example, if the lasting time of a Lithium Ion battery measured currently is 60 minutes, from the wear-out curve for the battery, one may find a corresponding equivalent number of life cycles the battery has consumed so far, e.g., 210 life cycles. If the ideal number life cycles of the battery when it is new is specified as 1000, then the remaining life of the battery is approximately 790 life cycles.

The wear-out curve in FIG. 1 may be converted into a wear-out lookup table, e.g., Table 1 in the following. Once the lasting time is obtained for a battery, a user, a system or a device using the battery may look up the Table 1 to find the corresponding value for the equivalent number of life cycles the battery has performed.

TABLE 1

| | Equivalent number of life cycles |
|---|---|
| Lasting time (min) | performed |
| 77 | 0 |
| 76 | 1 |
| . . . | . . . |
| 70 | 50 |
| . . . | . . . |
| 66.5 | 100 |
| . . . | . . . |

The data (i.e., wear-out data) representing the wear-out curve of batteries in a category, either in curves, tables or other applicable formats, may be predetermined from benchmark battery groups and stored for looking up. For example, a number of samples for different types of batteries may be chosen to obtain the wear-out curves for each battery type. Alternatively, battery samples from different batches of the same type of battery may be chosen to obtain the wear-out curves corresponding to the different batches. Once the battery samples are chosen, the wear-out curves can be predetermined from the complete charge and discharge cycles of the sample batteries. The battery voltage-charging time function V(t) for a category of batteries may be obtained in the same way as the wear-out curves, and stored in tables or a database, or other applicable forms.

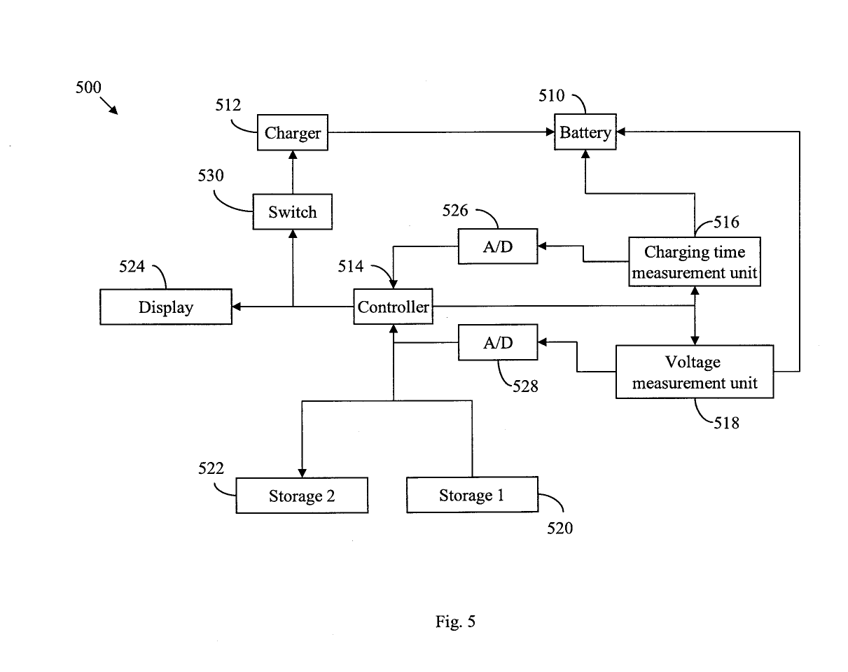

Referring to FIG. 5, an embodiment of a system 500 for determining battery life is illustrated. The system 500 includes a rechargeable battery 510, and a charger 512 capable of charging the battery. As the charger 512 begins to charge the battery 510, a controller 514 controls a charging time measurement unit 516, e.g., a timer, to begin to record the charging starting time of the battery 510. The controller may be a Central Processing Unit (CPU), or a Micro Controller Unit (MCU), or any other equivalents. Then, the controller 514 controls a voltage measurement unit to measure the charging voltage of the battery 510 at certain frequencies, and at the same time controls the charging time measurement unit to record the time the battery voltage is measured.

The measured charging starting time, the battery voltage, and the time the battery voltage is measured are sent to an analog-to-digital converter 526 and 528 to be converted into digital format, and sent to the controller 514.

The controller 514 receives the measured charging voltage of the battery 510, and determines whether the charging voltage has reached a threshold voltage pre-obtained. If the charging voltage is equal to the threshold voltage, the controller 514 stops the charging through a switch 530, and controls the charging time measurement unit 516 to record the charging ending time. If the battery 510 has been fully discharged before this charging cycle, the lasting time of the battery 510 at this charging cycle is calculated as the difference between the charging starting time and the charging ending time. The controller may store the measured charging voltage, charging starting time, charging ending time, and the lasting time in a Storage 1 520.

If the battery 510 has not been fully discharged before this charging cycle, the controller 514 may use the measured charging starting time, charging ending time, the battery voltage-charging time function V(t) for the battery, and the equation (2) to calculate the lasting time for the battery at this charging cycle.

The wear-out data used to determine the equivalent life cycles the battery has worked, as described above, the battery voltage-charging time function V(t) for the battery, and the threshold voltage may be predetermined and stored in a Storage 2 522 beforehand. The data may be stored in various applicable formats and manner, such as in a database, or a series of tables. The Storage 2 522 may be a local storage device or a remotely accessed storage device. The Storage 1 520 may be just a buffer, or combined with Storage 2 522 as one storage device.

The controller 514 uses the predetermined wear-out data stored in the Storage 2 522 and the calculated lasting time to determine the equivalent number of life cycles the battery has performed. For example, if the wear-out data is stored in a number of tables, the lasting time obtained may be used as an entry to find the corresponding number of life cycles. The charging voltage, lasting time, and equivalent number of life cycles may all be stored in Storage 1 520 or Storage 2 522 for future use.

The number of equivalent life cycles determined may then be displayed in a display device 524 as a numerical value, using a battery life bar, or in any other applicable forms.

The system 500 may be a device which the battery 510 supplies power to, e.g., a laptop, a cell phone, etc. The charging time measurement unit 516, voltage measurement unit 518, analog-to-digital converters 526 and 528 and/or the controller 514 may be an integrated circuit of the system 500, be made into a single unit, or be integrated with the battery 510 where the battery 510 can output digital results to the system.

The present invention may be applied to a variety of rechargeable batteries, such as Nickel-Cadmium (NiCd) batteries, Lithium batteries, Lead Acid batteries, nano wire batteries, or Nickel-Metal Hydride (NiMH) batteries, etc. Once the wear-out data is obtained, the life of a battery may be easily determined by using lasting time of battery, which may also be easily obtained under various working conditions.

What is claimed is:

1. A method for determining life of a rechargeable battery, comprising the steps of:
providing data representing relationship between lasting time of the battery and equivalent number of life cycles of the battery;
obtaining lasting time of the battery in charging; and
determining the life of the battery utilizing the obtained lasting time and the data provided.

2. The method of claim 1, further comprising providing a threshold voltage for the battery.

3. The method of claim 2, wherein the threshold voltage is a fast charging threshold voltage.

4. The method of claim 2, wherein the battery is charged using a constant current and constant voltage charging method.

5. The method of claim 4, wherein the lasting time is obtained by utilizing the charging time measured at the end of the constant current charging.

6. The method of claim 2, wherein the battery is charged using a variable current or variable voltage charging method.

7. The method claim 2, wherein the battery is charged using a fast charging method.

8. The method of claim 2, wherein the lasting time is obtained by measuring the charging time when the battery voltage of the battery reaches the threshold voltage, if the battery has been fully discharged before the charging.

9. The method of claim 2, further comprising providing data V(t) representing relationship between battery voltage and charging time of the battery, wherein, if the battery is not fully discharged before the charging, the lasting time is obtained by using
$$Δ t = Δ {t}^{′} * \frac{{\int }_{tb}^{tl} V ( t ) d t}{{\int }_{ta}^{tl} V ( t ) d t}$$
Wherein Δt is the lasting time, tb is the charging starting time, tl is the charging ending time, Δt′=tl−tb, and Δt=tl−ta.

10. The method of claim 1, wherein the step of determining the life of the battery comprising determining the equivalent number of life cycles the battery has performed.

11. The method of claim 1, wherein the battery is a Lithium battery, a NiCd battery, a Lead Acid battery, nano wire battery, or a NiMH battery.

12. A system for determining life of a rechargeable battery, comprising:
a storage unit adapted to store wear-out data representing relationship between lasting time of the battery and equivalent number of life cycles of the battery and a threshold voltage;
a charging time measurement unit adapted to measure time when battery is being charged;
a voltage measurement unit adapted to measure voltage of the battery; and
a controller unit adapted to determine lasting time of the battery in charging utilizing the time measured by the charging time measurement unit and the voltage measured by the voltage measurement unit, and to determine the life of the battery utilizing the data stored in the storage unit and the lasting time.

13. The system of claim 12, wherein the threshold voltage is a fast charging threshold voltage.

14. The system of claim 12, wherein the lasting time is determined using the charging time when the battery voltage of the battery reaches the threshold voltage, if the battery has been fully discharged before the charging.

15. The method of claim 12, wherein, the storage unit is adapted to store data V(t) representing relationship between battery voltage and charging time of the battery, and if the battery is not fully discharged before the charging, the lasting time is determined by using
$$Δ t = Δ {t}^{′} * \frac{{\int }_{tb}^{tl} V ( t ) d t}{{\int }_{ta}^{tl} V ( t ) d t}$$
wherein Δt is the lasting time, tb is the charging starting time, tl is the charging ending time, Δt′=tl−tb, and Δt=tl−ta.

16. The system of claim 12, wherein, the battery is charged using a constant current and constant voltage charging method.

17. The system of claim 16, wherein the lasting time is obtained by utilizing the charging time measured at the end of the constant current charging.

18. The system of claim 12, wherein the battery is charged using a variable current or variable voltage charging method.

19. The method claim 12, wherein the battery is charged using a fast charging method.

20. The system of claim 12, wherein the life of the battery is determined by determining the equivalent number of life cycles the battery has performed.

21. The system of claim 12, wherein the battery is a Lithium battery, a NiCd battery, a Lead Acid battery, a nano wire battery, or a NiMH battery.

22. The system of claim 12, further comprising at least one analog-to-digital converter for converting the measured time or voltage into a digital form.
